(19) United States
(12) Patent Application Publication
(10) Pub. No.: US 2002/0124418 A1
(43) Pub. Date: Sep. 12, 2002

(54) Utility knife tool

(76) Inventor: Earl J. Votolato, Newport Beach, CA (US)

Correspondence Address: STETINA BRUNDA GARRED & BRUCKER, 75 ENTERPRISE, SUITE 250, ALISO VIEJO, CA, 92656, US

(21) Appl. No.: 09/804,451

(22) Filed: Mar. 12, 2001

(51) Int. Cl. B26B 3/08

(52) U.S. Cl. 30/294

(57) ABSTRACT

A utility knife tool having a handle with a distal portion and a blade extending therefrom. A blade cover for covering the blade is integral with the tool and cooperates with a blade cover retainment member for lockedly maintaining the blade cover in a position covering the blade when the tool is not in use. A hand operable releaser is provided for releasing the locked retainment member, while a hand operable blade cover driver moves the blade cover an exposure distance for exposing the blade. Also included is an intercept member for disengaging the blade cover driver upon blade movement exceeding the exposure distance as may occur in a panic or emergency situation during tool use such that the blade cover is automatically dispatched to the locking configuration covering the blade.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

This invention relates in general to utility knives for cutting generally thick materials, and in particular to a utility knife tool having a blade guard locked in place over a knife blade until an integral release mechanism is activated, and immediately returned to the locked position upon user input indicating a potentially unsafe operating condition.

Handheld utility knife tools typically have an extremely sharp blade protruding forward from a housing, and are routinely used by workers for opening boxes, cutting cardboard and other types of sheet material, cutting carpet, and like instances where a razor-sharp blade is required or advantageous. The housing generally functions as a substantially straight handle for the user to grip, and may include such features as finger contouring and a relatively large diameter to thereby attempt to provide an effective hand-comfortable design.

Because of the extremely sharp protruding blade, the presently available typical utility knife can be quite dangerous should a user accidentally come in contact with the blade. One manner in which the prior art has addressed such danger is to provide a friction-fit, non-attached cap for placement over the blade portion of the knife when the tool is not in use. When this cap is in place, the knife is safe to handle. Unfortunately, however, potential injury continues to exist during cap placement and removal procedures, as well as during unexpected blade travel while the knife is in use.

In view of the widespread use of utility knives coupled with the dangers as exemplified above, it is apparent that a need is present for a more safely operable and storable knife tool. Accordingly, a primary object of the present invention is to provide a utility knife tool having integral therewith a blade cover which is automatically deployed when the tool is not in use.

Another object of the present invention is to provide a utility knife tool wherein the blade cover is automatically locked in place when covering the blade and releasable only upon conscious input by a user.

Yet another object of the present invention is to provide a utility knife tool wherein the blade cover automatically moves to a blade-covering configuration during tool use when a potentially untoward hand movement of the user is reflected in an untoward movement of the tool.

These and other objects of the present invention will become apparent throughout the description thereof which now follows.

### BRIEF SUMMARY OF THE INVENTION

The present invention is a utility knife tool. The tool includes a handle with a distal portion and a blade secured to and extending from the distal portion. A blade cover for covering the blade when the tool is not in use is integral with the tool and cooperates with a blade cover retainment member for lockedly maintaining the blade cover in a position covering the blade. To permit blade exposure, a hand operable releaser is provided for releasing the retainment member from a locking configuration, while a hand operable blade cover driver moves the blade cover an exposure distance for exposing the blade. Also included is an intercept member for disengaging the blade cover driver upon blade movement exceeding the exposure distance as may occur in a panic or emergency situation during tool use. When this event occurs, the blade cover is automatically dispatched to the locking configuration covering the blade.

In a preferred embodiment, the releaser and diver are incorporated as a trigger assembly in which a finger-movable trigger lever extends from the handle and functions first to release the retainment member and second to move the blade cover the above-defined exposure distance. Continued movement of the trigger lever, such as that which may automatically occur in a panic situation, causes contact of the blade cover with the intercept member which causes disengagement of the trigger lever from the blade cover and the return of the blade cover to a locked position covering the cutting edge of the blade. In this manner, the utility knife tool here defined promotes enhanced operator safety through a positive blade cover which is locked in place except for conscious and intentional blade exposure during tool use.

### BRIEF DESCRIPTION OF THE DRAWINGS

An illustrative and presently preferred embodiment of the invention is shown in the accompanying drawings in which:

FIG. 1 is a side perspective view of an assembled utility knife tool;

FIG. 2 is an open exploded perspective view of the knife tool of FIG. 1;

FIG. 3 is a side elevation view in section showing the tool components in place in a non-use configuration;

FIGS. 4A and 4B are partial side elevation views in section of blade cover release and travel initiation upon trigger movement;

FIG. 5 is a side elevation view in section showing the blade cover retracted an exposure distance to expose the blade;

FIG. 6 is a side elevation view in section showing movement of the blade cover beyond the exposure distance;

FIG. 7 is a side elevation view in section showing a return of the blade cover to position covering the cutting edge of the blade; and

FIG. 8 is a perspective view of the blade cover and blade cover retainment member.

### DETAILED DESCRIPTION OF THE INVENTION

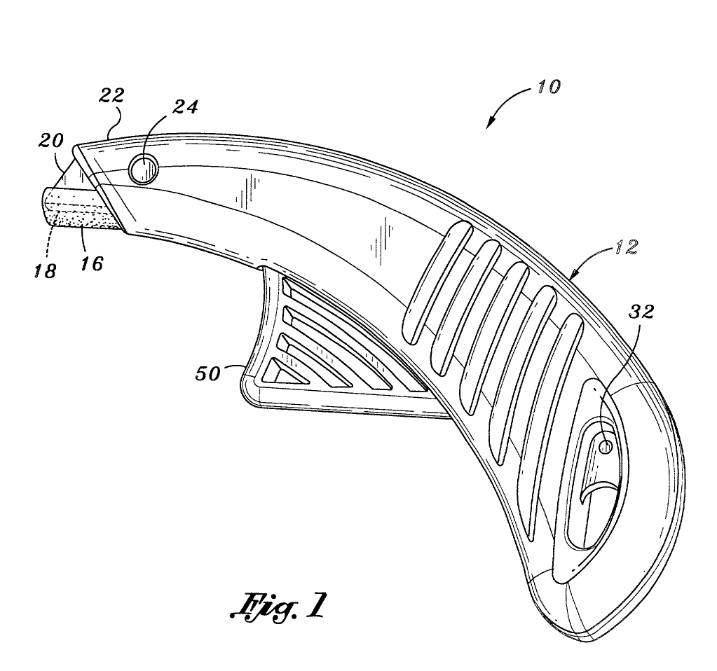

Referring first to FIGS. 1-3, a preferably disposable utility knife tool 10 is illustrated having a handle 12 constructed of two opposing pieces 12a, 12b that form a generally hollow interior portion 14. A generally cylindrical hollow blade cover 16 is integral with the tool 10 and covers the cutting edge 18 of a blade 20 when the tool 10 is not in use. The blade 20 extends from the distal portion 22 of the handle 12 and is secured between the two opposing pieces 12a, 12b thereof with a conventional rivet 24 passing through the handle apertures 26a, 26b and aligned blade aperture 28 therebetween. A longitudinal slit 30 in the wall of the blade cover 16 permits the blade 20 to reside there through. A second rivet 32 passes through both pieces 12a, 12b of the handle 12 near its proximal end to thereby maintain handle integrity.

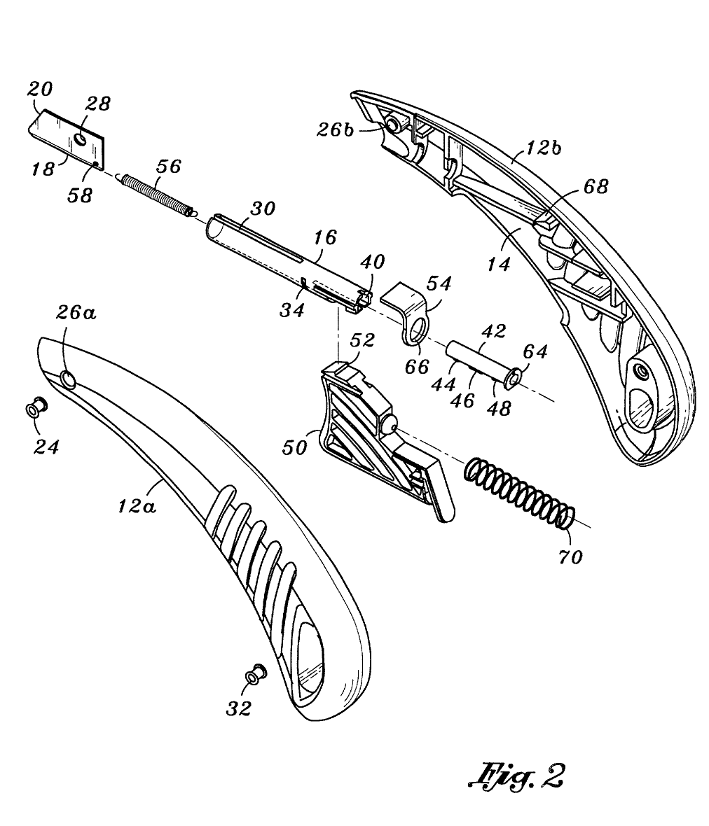

As particularly shown in FIGS. 2, 3, and 8, the underside of the blade cover 16 includes a transverse opening 34, a longitudinal opening 36 extending proximal of the transverse opening 34, and a ledge 38, while the blade cover 16 itself has a proximal opening 40 through which projects a hollow cylindrical releaser 42 having a distal double ramp projection 44, a central block projection 46, and a proximal ledge projection 48. An exteriorly accessible finger-movable trigger lever 50 extends from the handle 12 and has a hook 52 projecting toward the blade cover 16. The trigger lever 50 is urged distally by a conventional compression spring 70 positioned within the handle 12 as shown in FIG. 3. Extending within the hollow interior portion 14 of the handle 12 is a locking ring 54 through which the blade cover 16 resides and travels. Finally, a return spring 56 extends from a blade aperture 58 and through the releaser 42 to a releaser aperture 62 situated in a proximal rim 64 of the releaser 42 to thereby urge the releaser 42 distally. As is apparent, the rim 64 prevents the releaser 42 from entering the interior of the releaser 42.

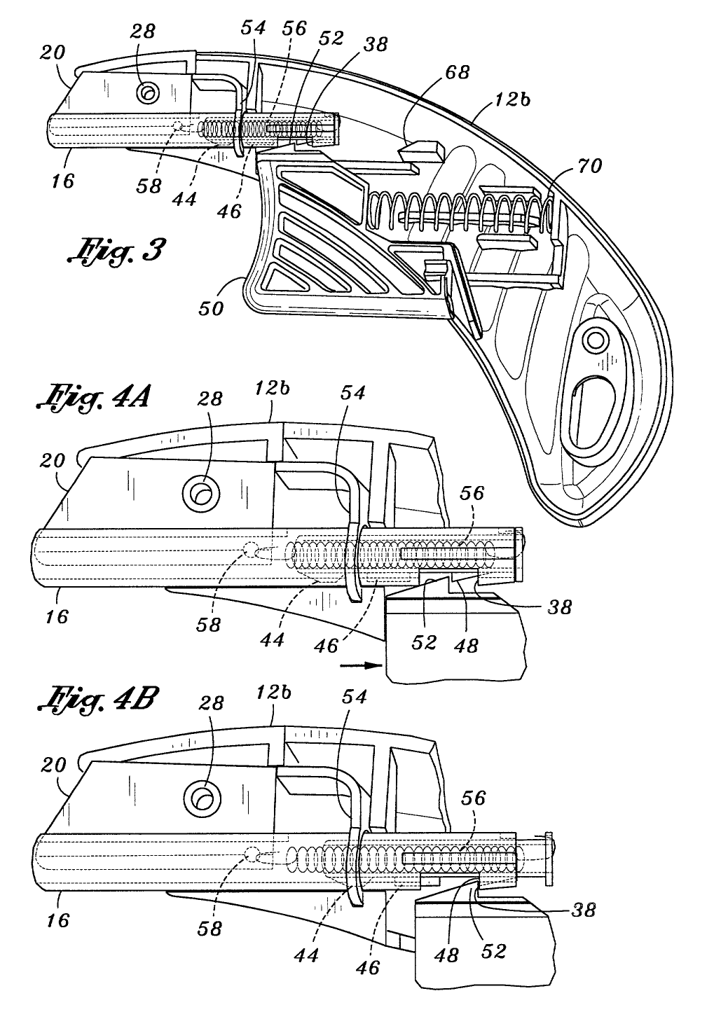

FIGS. 4A-7 illustrate sequential operability of the knife tool 10. As shown in FIG. 4A, prior to operation, the hook 52 of the trigger lever 50 is adjacent the proximal ledge projection 48 of the releaser 42 while the border 66 of the locking ring 54 resides in the transverse opening 34 of the blade cover 16 and the distal double ramp projection 44 of the releaser 42 is forward of the locking ring 54. Upon an initial trigger-lever finger movement as shown in FIG. 4B, which preferably is about one-eighth inch, the hook 52 engages the proximal ledge projection 48 of the releaser 42 and moves the releaser 42 and its proximal ledge projection 48 proximally such that the projection 48 reaches a position within the transverse opening 34 of the blade cover 16 to fill a portion of the transverse opening 34 and thereby release locking-ring retention of the cover 16. In particular, such release occurs because the proximal ledge projection 48, by filling a portion of the transverse opening 34 as above described, functions to replicate the diameter of the blade cover 16 within the transverse opening 34 and thereby move the locking ring 54 from the transverse opening 34 to thus allow passage of the blade cover 16 through the locking ring 54. Simultaneously, the hook 52 of the trigger lever 50 engages the ledge 38 of the blade cover 16 as clearly shown in FIG. 4B.

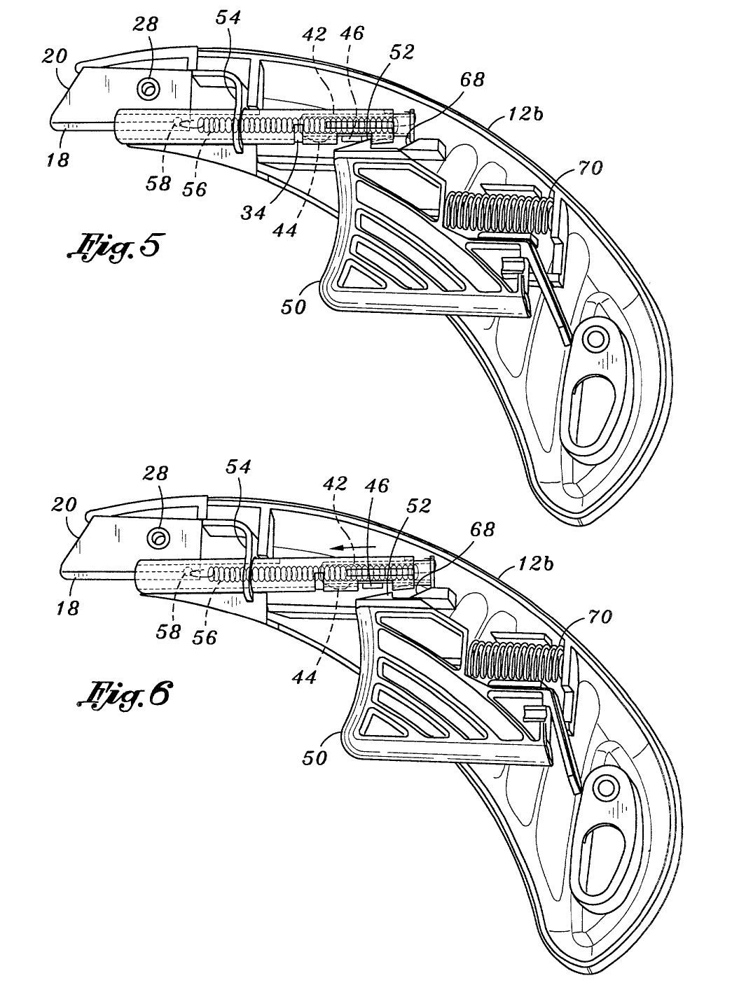

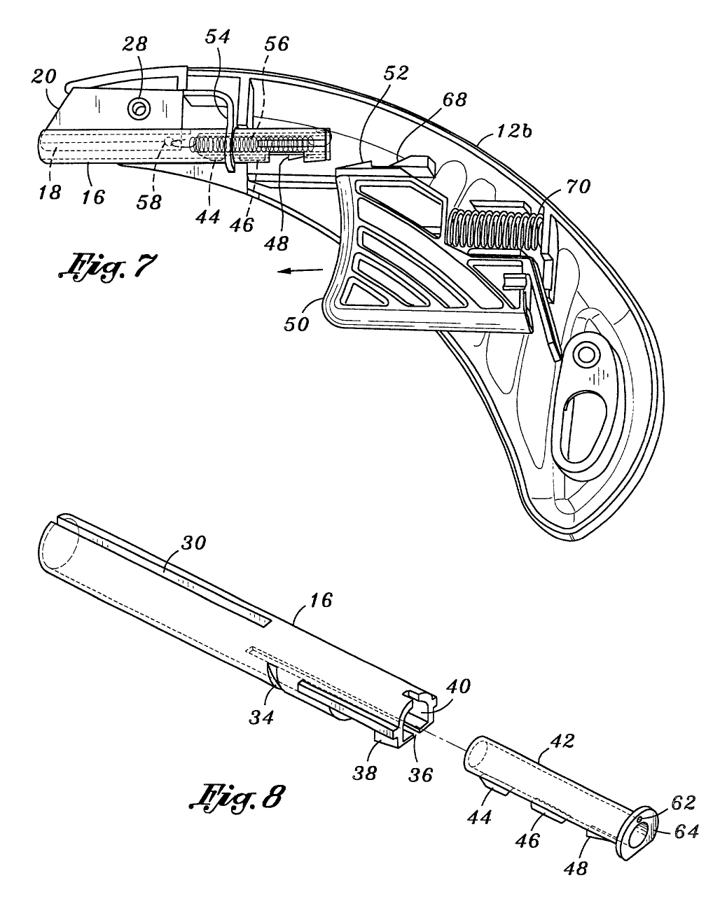

FIG. 5 illustrates the useful configuration of the knife tool 10. As there shown, the trigger lever 50 is moved proximally an exposure distance to thereby move the blade cover 16 proximally and expose the cutting edge 18 of the blade cover 16. As long as the trigger lever 50 is maintained in this position, the knife tool 10 is fully functional for cutting material. However, and as illustrated in FIGS. 6 and 7, if the trigger lever 50 is drawn proximally a further distance, as may occur in an emergency or hazardous situation, to thereby exceed the exposure distance, the proximal end of the releaser 42 becomes misaligned by striking the inclined ramp 68 within the travel path of the blade cover 16 inside the hollow interior portion 14 thereof and forces the hook 52 of the trigger lever 50 from the ledge 38 of the blade cover 16. When this occurs, the return spring 56 immediately draws the blade cover 16 distally to cover the cutting edge 18 of the blade 20 while the locking ring 54 simultaneously engages the transverse opening 34 of the blade cover 16 for locked immobility and resulting minimization of potential injury because of an exposed blade 16. In this manner, the knife tool 10 here defined permits both superb cutting efficiency and sensed potential injury to thereby provide equipment able to accomplish a favorable work product.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A utility knife tool comprising:
a) a handle with a distal portion;
b) a blade secured to and extending from said distal portion, said blade having a cutting edge;
c) an integral blade cover for covering the cutting edge of the blade when the tool is not in use;
d) a blade cover retainment member for lockedly maintaining the blade cover in a position covering the cutting edge of the blade;
e) a hand operable releaser for releasing the retainment member from a locking configuration;
f) a hand operable blade cover driver for moving the blade cover an exposure distance and exposing the cutting edge of the blade for use; and
g) an intercept member for disengaging the blade cover driver upon blade cover movement exceeding the exposure distance and dispatching the blade cover to the locking configuration covering the cutting edge of the blade.

2. A utility knife tool as claimed in claim 1 wherein the handle has a generally hollow interior portion, and wherein the blade cover is generally cylindrical with a wall having a longitudinal slit through which the blade resides.

3. A utility knife tool as claimed in claim 2 wherein the releaser and driver are incorporated as a trigger assembly comprising an exteriorly accessible finger-movable trigger lever extending from the handle and in engaged communication first with the retainment member for releasing said member from the locking configuration upon initial trigger lever movement and in engaged communication second with a proximal site of the blade cover for moving the blade cover said exposure distance upon continued trigger lever movement.

4. A utility knife tool as claimed in claim 3 wherein said retainment member and said proximal site of the blade cover are disposed within the generally hollow interior portion of the handle.

5. A utility knife tool as claimed in claim 4 wherein the intercept member is disposed within the generally hollow interior portion of the handle.

6. A utility knife tool as claimed in claim 5 wherein the intercept member is disposed within a travel path of the blade cover beyond said exposure distance for disengaging the engaged communication of the trigger lever with said proximal site of the blade cover.

7. A utility knife tool as claimed in claim 1 wherein the releaser and driver are incorporated as a single trigger assembly comprising an exteriorly accessible finger-movable trigger lever extending from the handle and in engaged communication first with the retainment member for releasing said member from the locking configuration upon initial trigger lever movement and in engaged communication second with a proximal site of the blade cover for moving the blade cover said exposure distance upon continued trigger lever movement.

8. A utility knife tool as claimed in claim 7 wherein said retainment member and said proximal site of the blade cover are disposed within the handle.

9. A utility knife tool as claimed in claim 8 wherein the intercept member is disposed within the handle.

10. A utility knife tool as claimed in claim 9 wherein the intercept member is disposed within a travel path of the blade cover beyond said exposure distance for disengaging said engaged communication of the trigger lever with said proximal site of the blade cover.
